(19) United States
(12) Patent Application Publication
(10) Pub. No.: US 2008/0104541 A1
(43) Pub. Date: May 1, 2008

(54) Method of assisting user interaction with a touch-screen device

(76) Inventors: Julie McDonald, Cupertino, CA (US); Peter K. Lee, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/591,687

(22) Filed: Nov. 1, 2006

(51) Int. Cl. G06F 3/048

(52) U.S. Cl. 715/810

(57) ABSTRACT

Embodiments of methods of assisting user interaction with a touch-screen device are described. In some embodiments, the method comprises operating a touch-screen device under a responsive state, wherein a touch-screen of the touch-screen device is capable of receiving user input, displaying a first user interface having a first list of user selectable items, and receiving a user selection of an item of the first list of user selectable items. Additionally, embodiments automatically transition to and display a second user interface having an associated list of user selectable items corresponding to the selected item.

### BACKGROUND

Nowadays, personal computers (PCs) are ubiquitous. Businesses, organizations, and individuals all depend on PCs to perform a variety of functions. Because end users may have dissimilar preferences, manufacturers have produced different types of PCs. On one side of the spectrum, manufacturers produce laptops to target mobile professionals and end users that desire a small computing device. On the other side of the spectrum, manufacturers produce powerful versatile desktops suitable for end users that utilize PCs for multimedia entertaining, video or photo editing, and/or gaming. As a result, a home often has one or more PCs to cater to different needs and preferences.

However, despite the wide selection of PCs available, to efficiently interact with a PC, a user usually conforms to one method of interaction that comprises booting up the PC, providing inputs via an alphanumeric input device, e.g., a keyboard, and/or a cursor control device, e.g., a mouse, and receiving outputs on a display, e.g. a monitor.

Although it is commonplace for a PC to have only one method of interaction with users, often this limitation can be inconvenient and troublesome. For example, a conventional barrier to use is that a user has to turn a PC on before any interaction occurs. And because the powering-up process is often not immediate, a user is prevented from performing a task, e.g., checking email, as quickly. In addition, with traditional input devices like keyboard and mouse, it is physically difficult for a user arriving home with, say, groceries, child, or briefcase in one hand to perform a simple task on the PC, e.g., checking for voice messages, with the other hand alone.

### BRIEF DESCRIPTION OF THE DRAWINGS

FIG. 1 illustrates a block diagram of an example of a system according to embodiments.

FIGS. 2A, 2B, and 2C illustrate an embodiment in operation when a communications item is selected.

FIGS. 3A, 3B, and 3C illustrate an embodiment in operation when a multimedia item is selected.

FIGS. 4A, 4B, and 4C illustrate an embodiment in operation when a photos item is selected.

FIG. 5 is a flow chart of a method of assisting user interaction with a touch-screen device operating under a responsive state, according to one embodiment.

FIG. 6 is a flow chart of a method of assisting user interaction with a touch-screen device operating under a bootless mode, according to one embodiment.

### DETAILED DESCRIPTION OF THE DRAWINGS

Reference will now be made in detail to embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be comprised within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details.

In contrast to traditional limitations, the present invention sets forth a method and an interface for a user to easily and efficiently interact with a PC; a user interface that provides a user friendly and efficient method for interacting with a PC.

Embodiments of a method of assisting user interaction with a touch-screen device, e.g., a touch-screen PC, are described. This comprises operating a touch-screen device under a responsive state (e.g., a specialized power saving mode that enables a user to leave the touch-screen device on an always ready mode), wherein a touch-screen of the touch-screen device is capable of receiving user input, e.g., manually inputting by touching the touch-screen with one hand. Embodiments display a first user interface having a first list of user selectable items that are frequently accessed. The list may comprise a photos item, a communications item, a multimedia item, and/or other frequently accessed items. In some embodiment, the first user interface is easily navigable with one hand. In some embodiments, this is achieved by designing a user interface that has easy to use short cuts and navigation keys that enable a user to easily access different items and provide different inputs. Moreover, embodiments receive a user selection of an item, e.g., email item, of the first list of user selectable items. Additionally, embodiments automatically transition to and display a second user interface having an associated list of user selectable items corresponding to the selected item, e.g., automatically transitioning to a screen showing a list of all emails if the communication item was selected from the first screen.

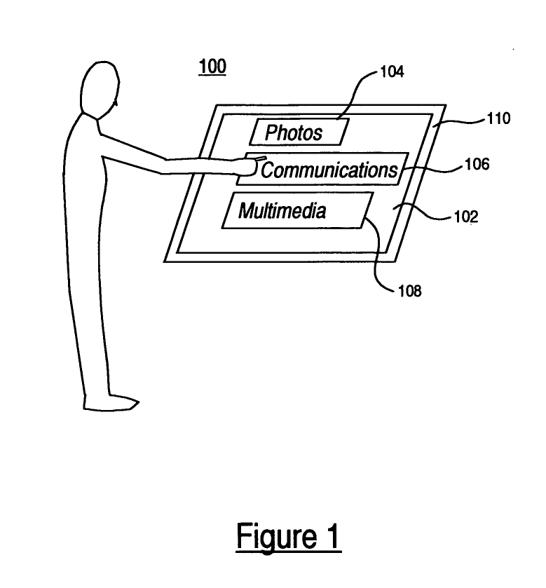

FIG. 1 illustrates a block diagram of an example of a system 100 according to embodiments. System 100 shows a touch-screen device 110, a touch-screen 102, a photos item 104, a communications item 106, and a multimedia item 108.

Although system 100 is shown and described as having certain numbers and types of elements, the claimed subject matter is not so limited; that is, system 100 may comprise elements other than those shown, and/or may comprise more than one of the elements that are shown.

The touch-screen device 110 operates under a responsive state and is continuously ready for receiving user input. The touch-screen device 110 uses any of a variety of technologies to detect user interaction, for example, the touch-screen device 110 can be pressure-sensitive, electrically sensitive, acoustically sensitive by monitoring surface acoustic wave, and/or photo-sensitive. Thus, a user can provide input in many ways as the touch-screen device 110. In one embodiment, a user can interact with touch-screen device 110 by touching touch-screen 102. In another embodiment, a user can use a stylus to write on touch-screen 102.

Because the touch-screen is continuously ready and does not require booting, a user may walk up to touch-screen device 110 and immediately begin interaction without waiting. The touch-screen 102 displays a first user interface having a first list of selectable items including a photos item 104, a communications item 106, and a multimedia item 108. Also, it is understood that, in other embodiments, other frequently accessed items or information may be displayed on the first user interface as well, e.g., a calendar showing the current date and/or a clock showing the current time.

Further, items on display 106 may be arranged in a variety of ways to maximize ease of interaction with a user. In one embodiment, the arrangement of items on display 106 is positioned as to benefit a user assuming a standing position. For example, the arrangement of items on display 106 may be designed to most efficiently interact with an average height person in a standing position. In another embodiment, the arrangement of items on display 106 is position as to benefit a user assuming a sitting position. For example, the arrangement of items on display 106 may be designed such that a disabled person sitting in an average-sized wheel-chair can easily utilize the touch-screen device 110. Also, the user can customize the arrangement of items.

Moreover, touch-screen device 110 may be attached to a base or other types of supporting structure. If attached to a base or other types of supporting structure, a user may be able to revolve, turn, shift, tilt, slant, rotate, swivel, raise, lift, lower, and/or move the touch-screen device 110 in other ways to achieve a desired operating angle with respect to the user.

Once a user has assumed a position to interact with touch-screen device, upon selection of an item displayed on a first user interface, the touch-screen 102 automatically transitions to and displays a second user interface based on user selection. For example, if a user touches the communications item 106, the touch-screen 102 automatically transitions to and displays a second user interface, which may display an associated list of user selectable items, e.g., a communications screen displaying an email item, a voice message item, a voice and video message item, and/or an instant message item. Further, in some embodiments, a user's selection of an item from the associated list of user selectable items automatically transitions to and displays a third user interface having another associated list of user selectable items and so on and so forth. Also, in one embodiment, the transitioning is pathwise bidirectional (i.e., the user can go in either direction along a selected path). Thus, a user can navigate from a second user interface back to a first user interface.

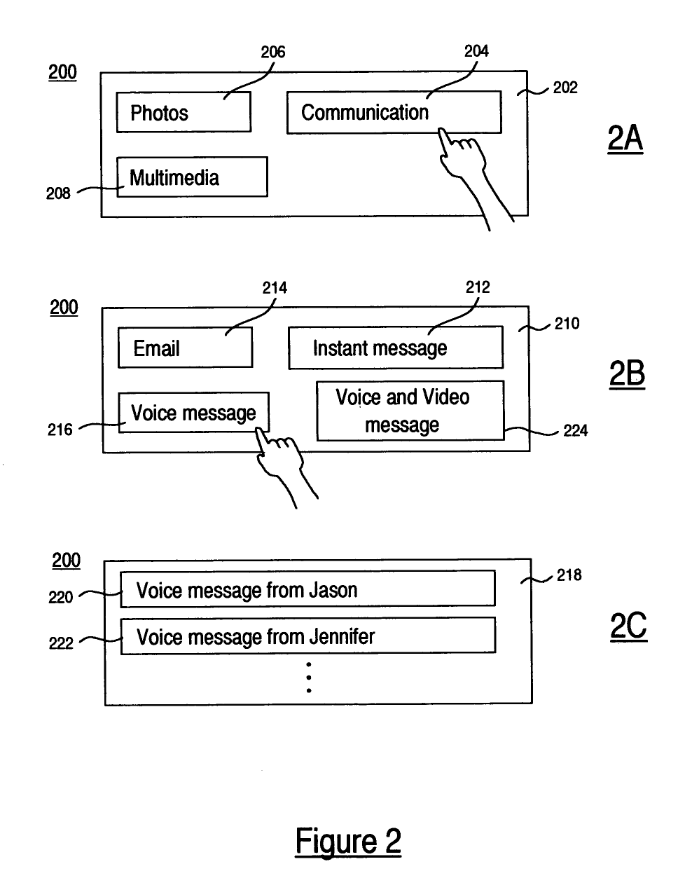

FIGS. 2A, 2B, and 2C illustrate a specific embodiment in operation. Although system 200 is shown and described as having certain numbers and types of elements, the claimed subject matter is not so limited; that is, system 200 may comprise elements other than those shown, and/or may comprise more than one of the elements that are shown.

As shown in FIG. 2A, system 200 displays an exemplary first user interface 202 that comprises a photos item 206, a communications item 204, and a multimedia item 208. The exemplary first user interface 202 is displayed on a touch-screen and capable of directly receiving manual input from a user. Also, photos item 206, communications item 204, and multimedia item 208 may each have an associated list of user selectable items. For example, communications item 204 may have an associated list of user selectable items (e.g., email, instant message, voice message, and voice and video message).

A user selects an item on the first user interface 202 by touching communications item 204. Upon selection, an exemplary second user interface 210 (shown in FIG. 2B) is automatically transitioned to and displayed. The second user interface 210 comprises an email item 214, an instant message item 212, a voice message item 216, and a voice and video message item 224. It is understood that any or all of email item 214, instant message item 212, voice message item 216, and voice and video message item 224 may each have another associated list of user selectable items. For example, voice message item 216 may comprise a list of all voice messages.

The user selects voice message item 216 and an exemplary third user interface (shown in FIG. 2C) is automatically transitioned to and displayed. The third user interface 218 comprises voice message from Jason 220 and voice message from Jennifer 222. By selecting a voice message, such as voice message from Jason 220 or voice message from Jennifer 222, the selected voice message is automatically played.

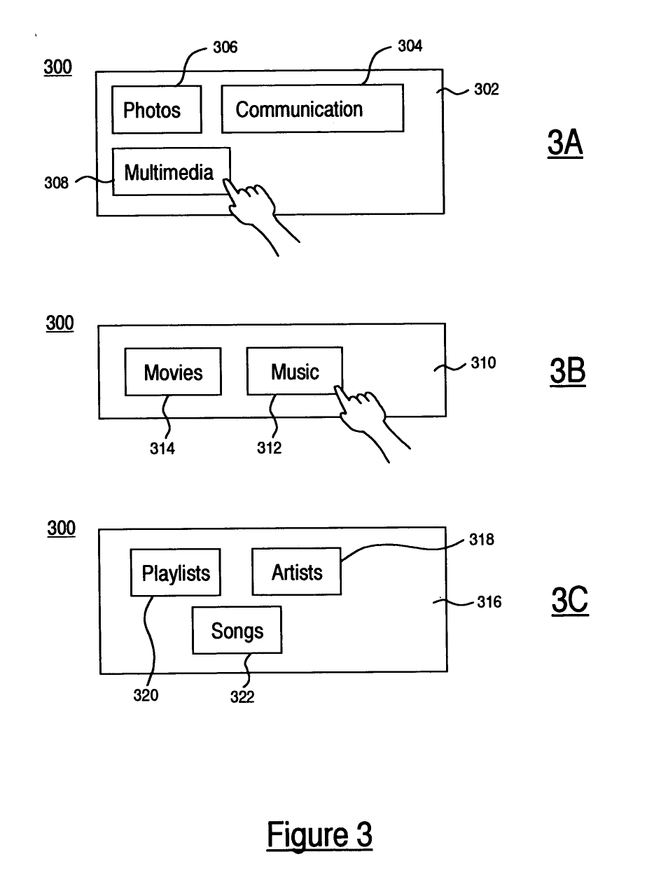

FIGS. 3A, 3B, and 3C illustrate a specific embodiment in operation. Although system 300 is shown and described as having certain numbers and types of elements, the claimed subject matter is not so limited; that is, system 300 may comprise elements other than those shown, and/or may comprise more than one of the elements that are shown.

As shown in FIG. 3A, system 300 displays an exemplary first user interface 302 that comprises a photos item 306, a communications item 304, and a multimedia item 308. The exemplary first user interface 302 is displayed on a touch-screen and capable of directly receiving manual input from a user. Also, photos item 306, communications item 304, and multimedia item 308 may each have an associated list of user selectable items. For example, multimedia item 308 may have another associated list of user selectable items comprising movies and music.

A user selects an item on the first user interface 302 by touching multimedia item 308. Upon selection, an exemplary second user interface 310 (shown in FIG. 3B) is automatically transitioned to and displayed. The second user interface 310 comprises movies 314 and music 312. Also, it is understood that either or both movies 314 and music 312 may each have another associated list of user selectable items. For example, music 312 may comprise organization items such as music organized by playlists, music organized by artists, and music organized by song tides.

The user selects music 312 and an exemplary third user interface (shown in FIG. 3C) is automatically transitioned to and displayed. The third user interface 316 comprises playlists 320, artists 318, and songs 322. Each of three items represents an organization scheme upon which a user may navigate through a collection of music. For example, if playlists 320 is selected, a fourth user interface having a list of selectable items, e.g., playlists that have different collections of music, may be automatically transitioned to and displayed. In another example, if artists 318 is selected, a user interface having a fourth list of selectable items, e.g., collections of music organized by artists, may be automatically transitioned to and displayed. Further, if songs 322 is selected, a user interface having a fourth list of selectable items, e.g., a collections of all music organized by song title, may be automatically transitioned to and displayed.

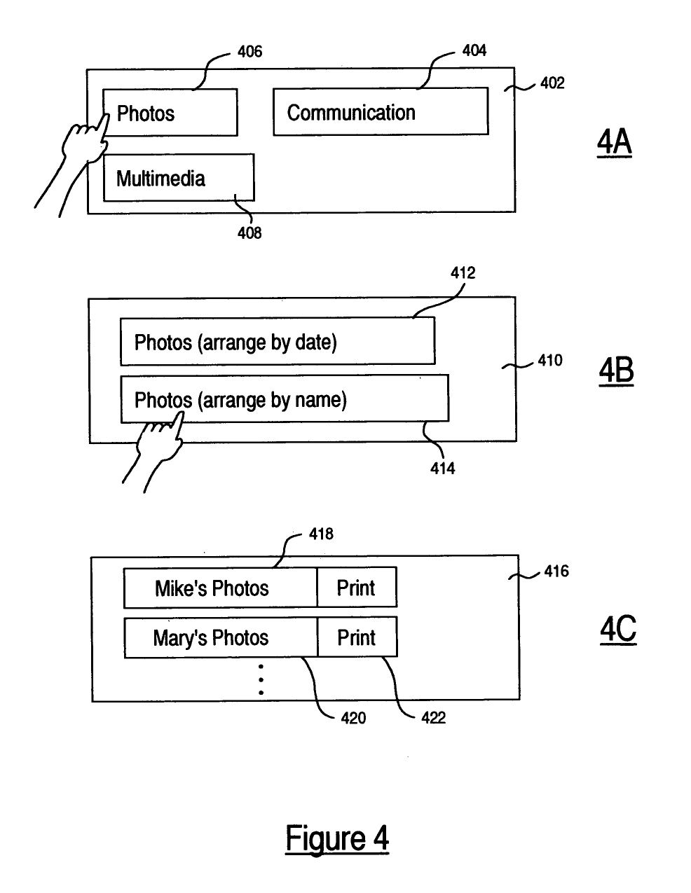

FIGS. 4A, 4B, and 4C illustrate a specific embodiment in operation. Although system 400 is shown and described as having certain numbers and types of elements, the claimed subject matter is not so limited; that is, system 400 may comprise elements other than those shown, and/or may comprise more than one of the elements that are shown.

As shown in FIG. 4A, system 400 displays an exemplary first user interface 302 that comprises a photos item 406, a communications item 404, and a multimedia item 408. The exemplary first user interface 402 is displayed on a touch-screen and capable of directly receiving manual input from a user. Also, photos item 406, communications item 404, and multimedia item 408 may each have an associated list of user selectable items. For example, photos item 406 may have third list of user selectable items comprising photos organized by date and photos organized by name.

A user selects an item on the first user interface 402 by touching photos item 406. Upon selection, an exemplary second user interface 410 (shown in FIG. 4B) is automatically transitioned to and displayed. The second user interface 410 comprises photos arranged by date 412 and photos arranged by name 414. Also, it is understood that photos arranged by date 412 and photos arranged by name 414 may each have another associated list of user selectable items. For example, photos arranged by name 414 may comprise a list of photos organized by name.

The user selects photos arranged by name and an exemplary third user interface (shown in FIG. 4C) is automatically transitioned to and displayed. The third user interface 416 comprises mike's photos 418, Mary's photos 420, and print 422. Mike's photos 418 comprises a list of all photos associated with Mike, and Mary's photos 420 comprises a list of all photos associated with Mary. Also, if a user selects a print 422 button, the photos associated with that particular print button are printed.

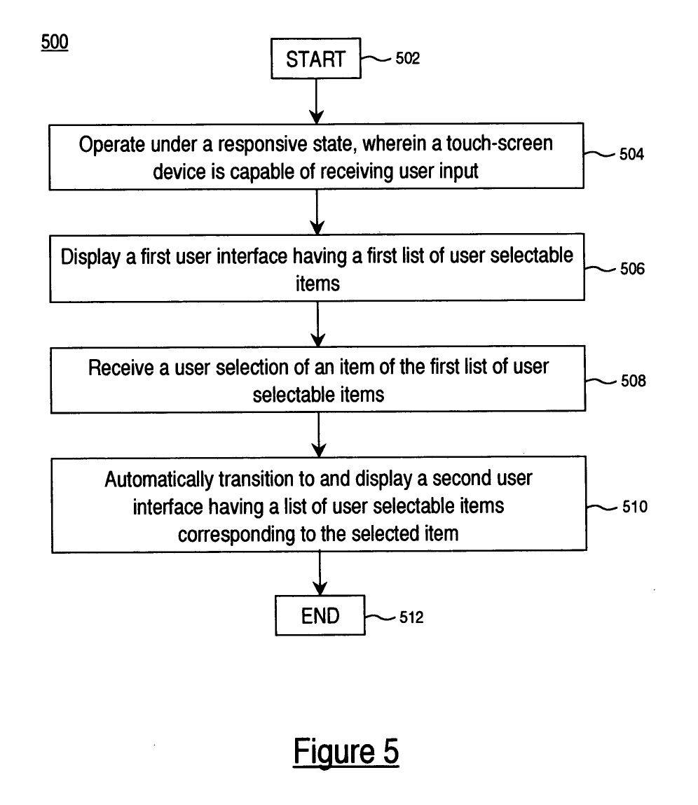

FIG. 5 is a flow chart 500 of a method of assisting user interaction with a touch-screen device, according to one embodiment. Although specific steps are disclosed in flowchart 500, such steps are exemplary. That is, embodiments are well suited to performing various other or additional steps or variations of the steps recited in flowchart 500. It is appreciated that the steps in flowchart 500 may be performed in an order different than presented.

At block 502, the process starts. At block 504, the touch-screen device is operating under a responsive state, wherein a touch-screen of the touch-screen device is capable of receiving user input. In one embodiment, the responsive state is continuously ready for receiving user input.

At block 506, a first user interface displays a first list of user selectable items. In some embodiments, the first list of user selectable items comprises at least one of a photos item, a communications item, and a multimedia item.

In one embodiment where the selected item is the multimedia item, then the associated list of user selectable items may comprise a playlists item having another associated list of user selectable items comprising a list of configurable playlists. Also, the associated list of user selectable items may comprise an artists item having another associated list of user selectable items comprising a list of all artists and a list of particular artists. Further, the associated list of user selectable items comprises a songs item having another associated list of user selectable items comprising a list of all songs.

In some embodiments if the selected item is the communications item, then the associated list of user selectable items may comprise a email item having another associated list of user selectable items comprising a list of all emails. Also, the associated list of user selectable items may comprise a voice message item having another associated list of user selectable items comprising a list of all voice messages. Further, the associated list of user selectable items may comprise a voice and video message item having another associated list of user selectable items comprising a list of all voice and video messages. Moreover, the associated list of user selectable items may comprise an instant message item having another associated list of user selectable items comprising a list of all instant messages.

In some embodiments if the selected item is the photos item, the associated list of user selectable items may comprise an arrange-by-dates item having another associated list of user selectable items comprising an ordered list of all photos by date. Further, the associated list of user selectable items may comprise a print command.

At block 508, a user selection of an item of the first list of user selectable items is received. In some embodiments, the user selection comprises a single action, e.g., a single touch. Also, receiving can be implemented in a variety of ways. In some embodiments, receiving comprises receiving user input from a stylus. A stylus can be a digitized pen capable of delivering pen-position input to the computer at a fast rate. In some embodiments, the stylus projects a small magnetic field above the touch-screen without affecting an image and only movement of the stylus affects an associated pointer. In another example, receiving comprises receiving user input from a graphics tablet, a computer peripheral device that enables one to hand draw images directly into a computer, generally via an imaging program.

At block 510, a second user interface having an associated further list of user selectable items corresponding to the selected item is automatically transitioned to and displayed. At block 512, the process ends.

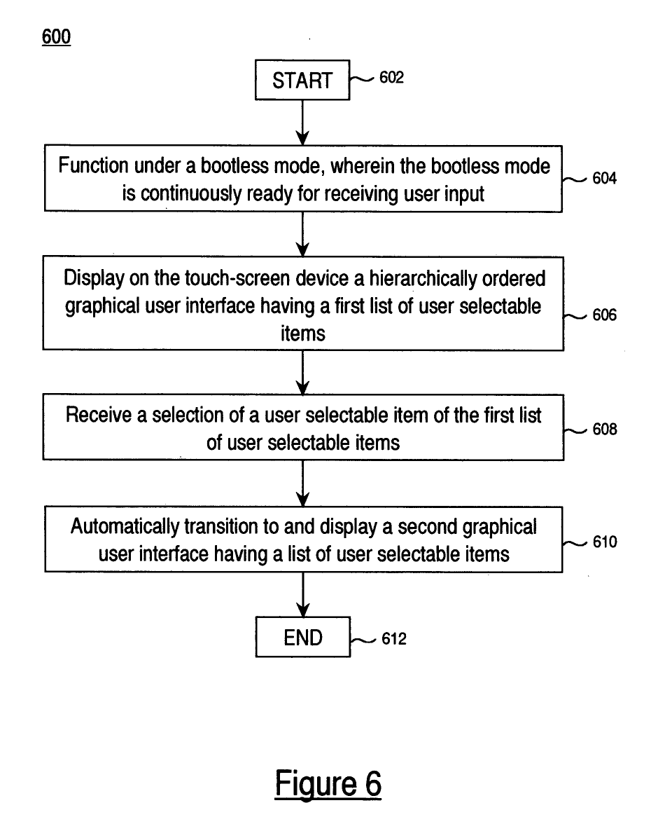

FIG. 6 is a flow chart 600 of a method of assisting user interaction with a touch-screen device, according to one embodiment. Although specific steps are disclosed in flowchart 600, such steps are exemplary. That is, embodiments are well suited to performing various other or additional steps or variations of the steps recited in flowchart 600. It is appreciated that the steps in flowchart 600 may be performed in an order different than presented.

At block 602, the process starts. At block 604, the touch-screen device is functioning under a bootless mode, wherein the bootless mode is continuously ready for receiving user input.

At block 606, a hierarchically ordered graphical user interface having a first list of user selectable items is displayed. The first list of user selectable items, in one example, comprises at least one of a photos item, a communications item, and a multimedia item. A graphical user interface can be a perceptual user interface (PUI) or a zooming user interface (ZUI) that utilizes 3-dimensional movement.

In some embodiments if the selected item is the multimedia item, then the associated list of user selectable items may comprise a playlists item having another associated list of user selectable items in turn comprising a list of configurable playlists. Also, the associated list of user selectable items may comprise an artists item having another associated list of user selectable items comprising a list of all artists and a list of particular artists. Further, the associated list of user selectable items may comprise a songs item having another associated list of user selectable items comprising a list of all songs.

If the selected item is the communications item, then the associated list of user selectable items may comprise a email item having another associated list of user selectable items comprising a list of all emails. Also, the associated list of user selectable items may comprise a voice message item having another associated list of user selectable items comprising a list of all voice messages. Further, the associated list of user selectable items may comprise a voice and video message item having another associated list of user selectable items comprising a list of all voice and video messages. Moreover, the associated list of user selectable items may comprise an instant message item having another associated list of user selectable items comprising a list of all instant messages.

If the selected item is the photos item, the associated list of user selectable items may comprise an arrange-by-dates item having another associated list of user selectable items comprising an ordered list of all photos by date. Further, the associated list of user selectable items may comprise a print command.

At block 608, a selection of a user selectable item of the list of user selectable items is received. In some embodiments, the selection comprises a single action, e.g., a single touch. Also, receiving can be implemented in a variety of ways. In some embodiments, receiving comprises receiving user input from a stylus. A stylus can be a digitized pen capable of delivering pen-position input to the computer at a fast rate. In some embodiments, the stylus projects a small magnetic field above the touch-screen without affecting an image and only movement of the stylus affects an associated pointer. In some embodiments, receiving comprises receiving user input from a graphics tablet, a computer peripheral device that enables one to hand draw images directly into a computer, generally via an imaging program.

At block 610, a second graphical user interface having a list of user selectable items is automatically transitioned to and displayed. In some embodiments, the transitioning is pathwise bidirectional (the user can go in either direction along a selected path, e.g., from a second graphical user interface back to a first graphical user interface). At block 612, the process ends.

What is claimed is:

1. A method of assisting user interaction with a touch-screen device, comprising:
operating under a responsive state, wherein a touch-screen of said touch-screen device is capable of receiving user input;
displaying a first user interface having a first list of user selectable items;
receiving a user selection of an item of said first list of user selectable items; and
automatically transitioning to and displaying a second user interface having an associated list of user selectable items corresponding to said selected item.

2. The method as recited in claim 1, further comprising:
displaying at least one of a photos item, a communications item, and a multimedia item.

3. The method as recited in claim 2, further comprising:
if said selected item is said multimedia item, displaying an associated list of user selectable items comprising a playlists item having another associated list of user selectable items comprising a list of configurable playlists.

4. The method as recited in claim 2, further comprising:
if said selected item is said multimedia item, displaying an associated list of user selectable items comprising an artists item having another associated list of user selectable items comprising a list of all artists and a list of particular artists.

5. The method as recited in claim 2, further comprising:
if said selected item is said multimedia item, displaying an associated list of user selectable items comprising a songs item having another associated list of user selectable items comprising a list of all songs.

6. The method as recited in claim 2, further comprising:
if said selected item is said communications item, displaying an associated list of user selectable items comprising a email item having another associated list of user selectable items comprising a list of all emails.

7. The method as recited in claim 2, further comprising:
if said selected item is said communications item, displaying an associated list of user selectable items comprising a voice message item having a further associated list of user selectable items comprising a list of all voice messages.

8. The method as recited in claim 2, further comprising:
if said selected item is said communications item, displaying an associated list of user selectable items comprising a voice and video message item having a further associated list of user selectable items comprising a list of all voice and video messages.

9. The method as recited in claim 2, further comprising:
if said selected item is said communications item, displaying an associated list of user selectable items comprising an instant message item having a farther associated list of user selectable items comprising a list of all instant messages.

10. The method as recited in claim 2, further comprising:
if said selected item is said photos item, displaying an associated list of user selectable items comprising a arrange by dates item having a further associated list of user selectable items comprising an ordered list of all photos by date.

11. The method as recited in claim 2, further comprising:
if said selected item is said photos item, displaying an associated list of user selectable items comprising a print command.

12. An integrated user interface for a touch-screen device comprising:
a first user interface having a first list of user selectable items, wherein said first list of user selectable items, and wherein selection of a user selectable item of said list of user selectable items automatically transitions said first user interface to a second user interface having an associated list of user selectable items corresponding to said user selectable item.

13. The integrated user interface of claim 12, wherein said first list comprises at least one of a photos item, a communications item, and a multimedia item.

14. The integrated user interface of claim 12, wherein said first user interface is operating under a responsive state, wherein said responsive state is continuously ready for receiving user input.

15. The integrated user interface as recited in claim 12, wherein said first user interface mode is easily operable with one hand.

16. The integrated user interface as recited in claim 12, wherein said first user interface is configured to be easily accessible to a user assuming a standing position.

17. The integrated user interface as recited in claim 12, wherein said user selection is performed by a voice command.

18. A method for interacting with a touch-screen device, comprising:
functioning under a bootless mode, wherein said bootless mode is continuously ready for receiving user input;
displaying on said touch-screen device a hierarchically ordered graphical user interface having a first list of user selectable items;
receiving a selection of a user selectable item of said first list of user selectable items; and
automatically transitioning to and displaying a second graphical user interface having an associated list of user selectable items.

19. The method as recited in claim 17, further comprising:
displaying said first list of user selectable items comprising at least one of a photos item, a communications item, and a multimedia item;

20. The method as recited in claim 17, further comprising:
receiving user input from a stylus.
